(19) United States
(12) Patent Application Publication
(10) Pub. No.: US 2009/0206026 A1
(43) Pub. Date: Aug. 20, 2009

(54) External pressure type hollow fiber membrane having reinforcing supporter with monofilament for gas separation and water treatment, and method and apprtatus for preapring the same

(76) Inventors: Ho Sung Yoon, Gyeonggi Province (KR); Sang Woo Park, Gyeonggi Province (KR); Jin Hve Jung, Gyeonggi Province (KR)

Correspondence Address: SHERIDAN ROSS PC, 1560 BROADWAY, SUITE 1200, DENVER, CO, 80202, US

(21) Appl. No.: 10/521,284

(22) PCT Filed: Jul. 18, 2003
(86) PCT No.: PCT/KR03/01428

§ 371 Date: Jan. 18, 2005

(30) Foreign Application Priority Data
Jul. 19, 2002 (KR) 10-2002-0042674

(51) Int. Cl. B01D 63/04; D01D 5/24

(52) U.S. Cl. 210/490; 96/10; 264/172.16; 425/462

(57) ABSTRACT

Disclosed are external pressure type hollow fiber membrane having a reinforcing supporter for gas separation and water treatment, and method and apparatus for preparing the same. The reinforcing supporter is woven only with mono-filaments or by mixed spinning of mono-filaments and multi-filaments. The hollow fiber membrane of the present invention has excellent pressure resistance and high tension force by using the rigid and tubular supporter, an improved softness by using the mono-filaments, and an increased bonding force between the supporter and the coating layer by increasing the concave-convexo degree of the reinforcing supporter. Additionally, the hollow fiber membrane can prevent detachment of the separating filtration layer, which is the coating layer, through the surface weight deduction treatment of the reinforcing supporter, and control the inner pore size of the membrane by treating the internal coagulating solution, thereby providing an excellent water-permeability.

### TECHNICAL FIELD

The present invention relates to external pressure type hollow fiber membrane for gas separation and water treatment, and method and apparatus for preparing the same, which can improve softness of membrane by including mono-filaments, increase bonding force through weight deduction treatment, and control the inner pore size of the membrane through internal coagulating solution. More particularly, the present invention relates to an external pressure type hollow fiber membrane formed in such a manner that only mono-filaments are woven or mono-filaments and multi-filaments mixed at a predetermined ratio are woven to form a tubular supporter, the supporter is spun with undiluted spinning liquid using a spinneret through a wetting step for controlling the inner pore size after selective surface weight deduction treatment of the supporter, and then, the liquid type coating layer is converted into solid type by being deposited in nonsolvent (external coagulating solution). Furthermore, the present invention relates to method and apparatus for preparing the external pressure type hollow fiber membrane manually and/or automatically.

### BACKGROUND ART

In general, as hollow fiber membrane has low strength, to use the hollow fiber membrane for water treatment, it is used in the form of a module without using the hollow fiber membrane in itself. In this case, a method to increase the flow rate of treated water inside the module or a method to shake the hollow fiber membrane is used to minimize pollution of membrane. However, the above methods have several restrictions on module-oriented or systemized hollow fiber membrane.

To solve the above problems, U.S. Pat. No. 5,472,607 discloses a method for thinly coating braid with selectively permeable membrane to reinforce intensity of the membrane. In U.S. Pat. No. 5,472,607, multi-filaments of 16˜60 yarns of 150˜500 deniers are used to form a tubular braid. However, the method has a disadvantage in that the thick tubular supporter formed by the multi-filaments of a single sort reduces softness of the membrane. Furthermore, there is possibility that a selectively permeable membrane coated on the braid is partially come off due to shock as there are few concave-convexo portions of the braid surface. Moreover, the method has a further disadvantage in that it is difficult to control the inner pore size of the membrane as internal coagulating solution is not used during the coating of the selectively permeable membrane, thereby reducing the merit of the hollow fiber membrane to expand the sectional area inside the module.

### DISCLOSURE OF INVENTION

The present invention has been invented through studies based on the concept that softness of membrane is improved by applying mono-filaments to a reinforcing supporter, and bonding force between the reinforcing supporter and separating filtration layer due to increase of concave-convexo portions is increased.

Therefore, an object of the present invention is to provide an external pressure type hollow fiber membrane having a reinforcing supporter with mono-filaments for gas separation and water treatment.

Another objection of the present invention is to provide a method for preparing a hollow fiber membrane including internal coagulating solution treatment and surface weight deduction treatment of the reinforcing supporter.

A further objection of the present invention is to provide an apparatus for preparing hollow fiber membrane for automatically or manually carrying out internal coagulating solution treatment and spinning processes.

### BRIEF DESCRIPTION OF DRAWINGS

Further objects and advantages of the invention can be more fully understood from the following detailed description taken in conjunction with the accompanying drawings in which:

FIG. 1 is a structural view of a reinforcing supporter of diamond structure woven by mixed spinning of multi-filaments and mono-filaments;

FIG. 2 is a photograph of the reinforcing supporter woven with 32 yarns by mixing multi-filaments (135 deniers) and mono-filaments (130 deniers) at a predetermined ratio;

FIG. 3 is a structural view of a reinforcing supporter of diamond structure woven only with mono-filaments;

FIG. 4 is a photograph of the reinforcing supporter woven with the mono-filaments (130 deniers) of 32 yarns;

FIG. 5 is a photograph of the reinforcing supporter woven with the mono-filaments (130 deniers) of 24 yarns;

FIG. 6 is a sectional view of an automated apparatus for preparing a hollow fiber membrane according to the present invention;

FIG. 7 is a sectional view of an internal coagulating solution injector of FIG. 6;

FIG. 8 is a sectional view of a spinneret of FIG. 6;

FIG. 9 is a sectional view of a spinneret for a manual wetting process according to another embodiment of the present invention;

FIG. 10a is a sectional view of the hollow fiber membrane having the reinforcing supporter by mixed spinning of the mono-filaments and multi-filaments when a wire is used;

FIG. 10b is a sectional view of the hollow fiber membrane having the reinforcing supporter by mixed spinning of the mono-filaments and multi-filaments when the wire is not used;

FIG. 10c is a photograph of the hollow fiber membrane of FIG. 10a; and

FIG. 11 is a sectional view of the hollow fiber membrane having the reinforcing supporter only with the mono-filaments (a: when a wire is used, b: when the wire is not used)

### BEST MODE FOR CARRYING OUT THE INVENTION

The present invention will now be described in detail in connection with preferred embodiments with reference to the accompanying drawings. For reference, like reference characters designate corresponding parts throughout several Figures.

A hollow fiber membrane according to the present invention includes a reinforcing supporter woven by only mono-filaments or woven by mixed spinning of mono-filaments and multi-filaments.

The mono-filament means yarn having a filament, which is a thin yarn of the reinforcing supporter, and multi-filament means a yarn having a number of filaments.

The mono-filament can improve softness of the hollow fiber membrane as it is prepared thinner than the multi-filament, which is thick due to pores between filaments. Furthermore, the mono-filament can sufficiently form concave-convexo portions to improve bonding force between the mono-filament and a separate filtering layer by sufficiently forming concave-convexo portions as it is softer than the multi-filament, which is difficult in winding.

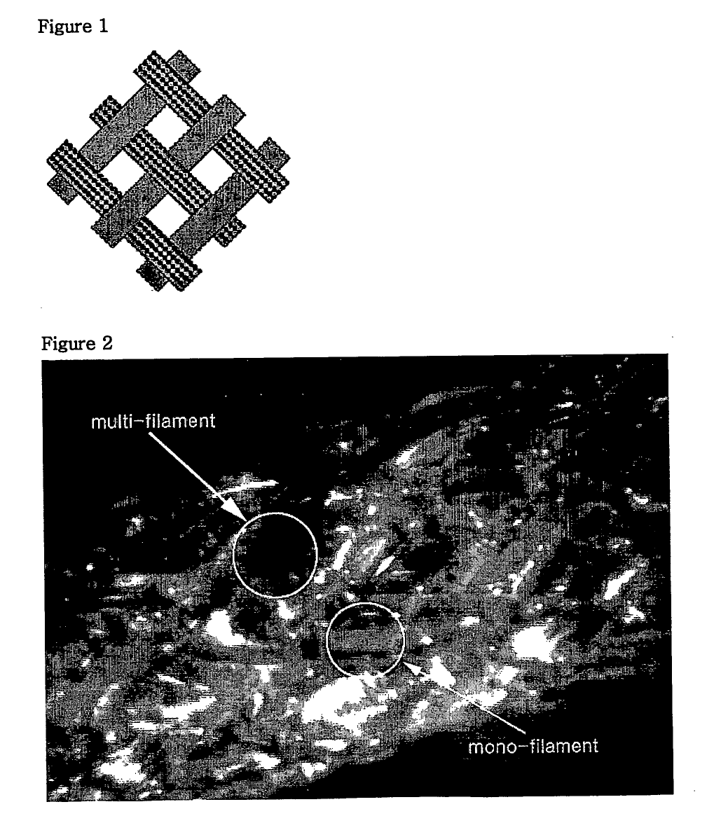

FIG. 1 is a structural view of the reinforcing supporter of a diamond structure woven by mixed spinning of the multi-filaments and the mono-filaments. FIG. 2 is a photograph of the reinforcing supporter woven with multi-filaments of 135 deniers and mono-filaments of 130 deniers, which are mixed at a predetermined ratio, and which are total 32 yarns.

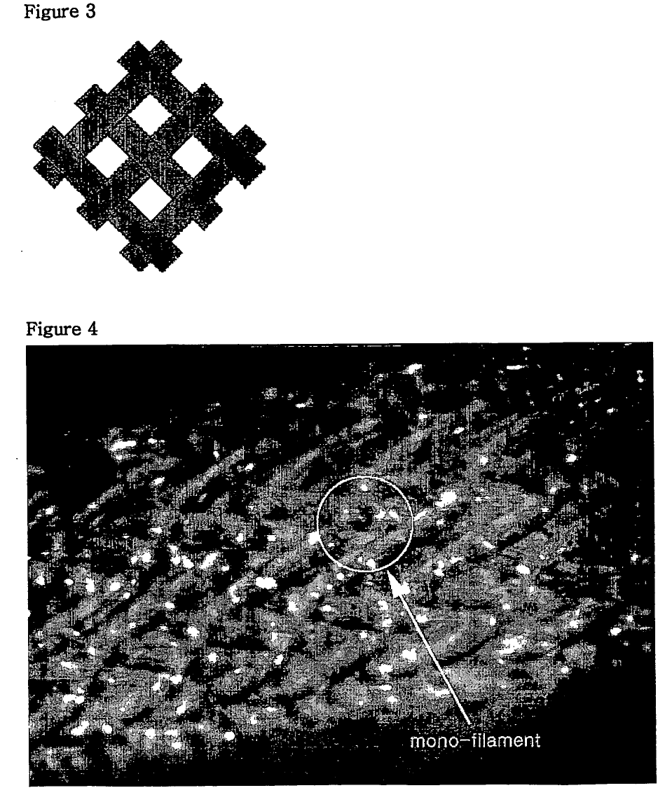

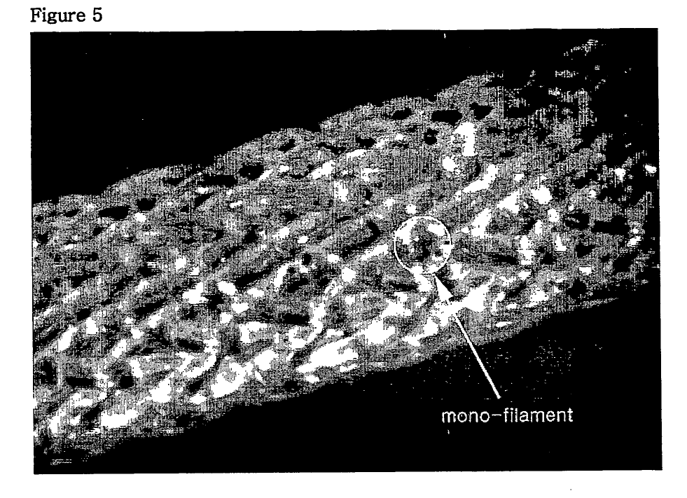

FIG. 3 is a structural view of the reinforcing supporter of a diamond structure woven only with the mono-filaments. FIG. 4 is a photograph of the reinforcing supporter woven with the mono-filaments of 130 deniers and of 32 yarns. FIG. 5 is a photograph of the reinforcing supporter woven with the mono-filaments of 130 deniers and of 24 yarns.

The mixed ratio of the mono-filaments and the multi-filaments is 1:1 to 63:1, and preferably, 2:1 to 7:1. As shown in FIGS. 1 to 5, as the number of the mono-filaments is increased, the concave-convexo portions are also increased. Therefore, in the mixed ratio, it is preferable that the number of the mono-filaments is larger than that of the multi-filaments. However, because the merits of the multi-filaments are reduced if the number of the mono-filaments is too large, a proper mixed ratio is 2:1 to 7:1. The yarn number of the reinforcing supporter is varied according to a used weaving machine, but the reinforcing supporter is commonly woven with 8 to 64 yarns, and the yarn number can be controlled by multiple of 8.

If the mono-filaments and the multi-filaments are too thick, it is difficult to manufacture the reinforcing supporter or to manufacture a thinner reinforcing supporter. So, the mono-filaments and the multi-filaments of 30 to 450 deniers are proper, and preferably, 30 to 150 deniers as it is good as thin as possible.

Materials of the reinforcing supporter are not restricted, but it is good to use polyester or nylon, which are inexpensive materials, in consideration of manufacturing costs. Furthermore, it is preferable to use the reinforcing supporter weight-deducted. The weight deduction treatment can increase a concave-convexo degree of the reinforcing supporter and decrease thickness of the hollow fiber membrane.

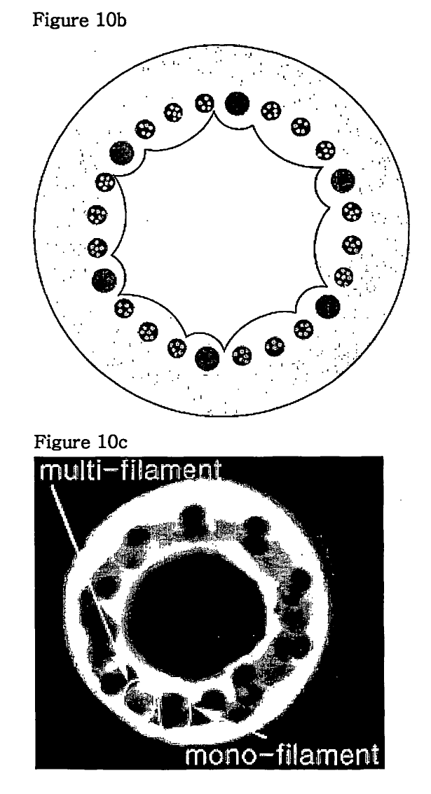

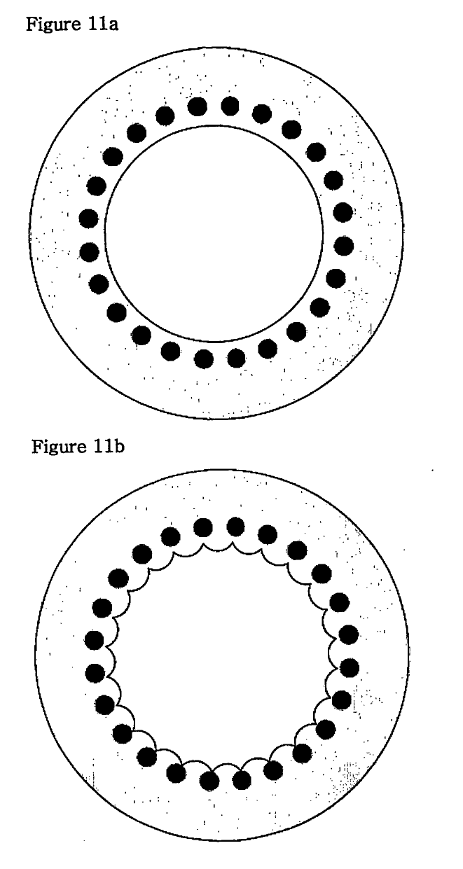

The hollow fiber membrane of the present invention includes a separating filtration layer, the reinforcing supporter and a hollow. In concrete, the hollow fiber membrane includes: a tubular separating filtration layer formed with hollow yarns; a reinforcing support for supporting the separating filtration layer; and a hollow formed inside the reinforcing supporter (see FIGS. 10 and 11). Because a part, concretely 0.1 to 80%, of undiluted spinning solution(polymer) of the separating filtration layer penetrates pores between lattices of the reinforcing supporter, also the inside of the reinforcing supporter can be coated, and thereby, bonding force between the separating filtration layer and the reinforcing supporter is increased.

A method for preparing the hollow fiber membrane according to the present invention includes the steps of weaving the reinforcing supporter only with the mono-filaments or with the mono-filaments and the multi-filaments mixed with each other; and coating the prepared reinforcing supporter with undiluted spinning solution in the spinneret and discharging the reinforcing supporter to external coagulating solution to form the hollow fiber membrane.

At this time, preferably, the method for preparing the hollow fiber membrane further includes the steps of: treating the reinforcing supporter with the internal coagulating solution; and carrying out surface weight deduction treatment to the reinforcing supporter with alkali. The surface weight deduction treatment is to increase bonding force to the coated layer by forming irregular concave-convexo portions on the surface of the reinforcing supporter. Here, used alkali is NaOH or KOH aqueous solution of about 1 to 50% (w/v). The surface weight deduction treatment is carried out in alkali aqueous solution at the temperature of 70 to 150° C. for 10 to 180 minutes, and according to circumstances, alcohol, such as ethyl alcohol or propyl alcohol, can be added in the weight deduction step.

Compared with the when the weight deduction treatment was not carried out to the supporter, there is little difference in the weight-deduction rate as the bonding force between the polymer coating layer and the braid is weak if the average weight deduction rate of the reinforcing supporter is less than 5%, and the bonding force is reduced as the concave-convexo portions of the braid is decreased in spite of the average weight deduction rate of 80% or more. So, it is preferable that the average weight deduction rate is 5 to 80%.

The average concave-convexo degree of the reinforcing supporter is 20 to 25%, and the thickness of the coating layer (separating filtration layer) of the hollow fiber membrane prepared as the above is reduced 1% or more of that of the coating layer of the hollow fiber membrane non-deducted in weight. The weight-deducted supporter of the hollow fiber membrane becomes thinner and has the concave-convexo portions of the surface. So, the undiluted spinning solution can easily penetrate into the inside concave-convexo portions of the supporter, and thereby, the coating layer becomes thin when the phase of the undiluted spinning solution is changed from liquid type to solid type. As a result, the bonding force between the supporter and the coating layer is increased and a detached rate of the coating layer is reduced.

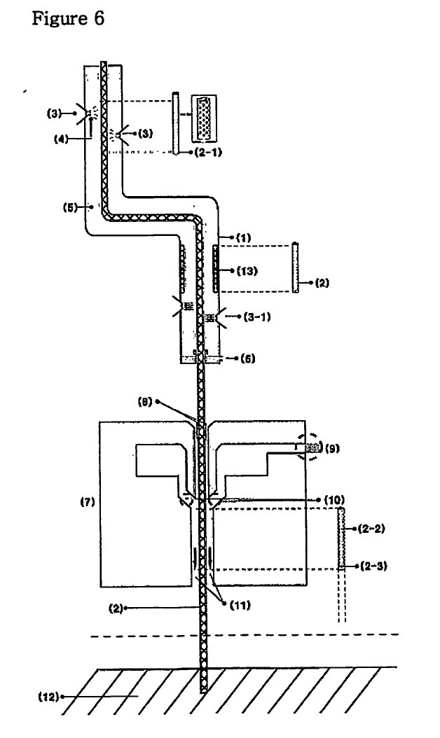

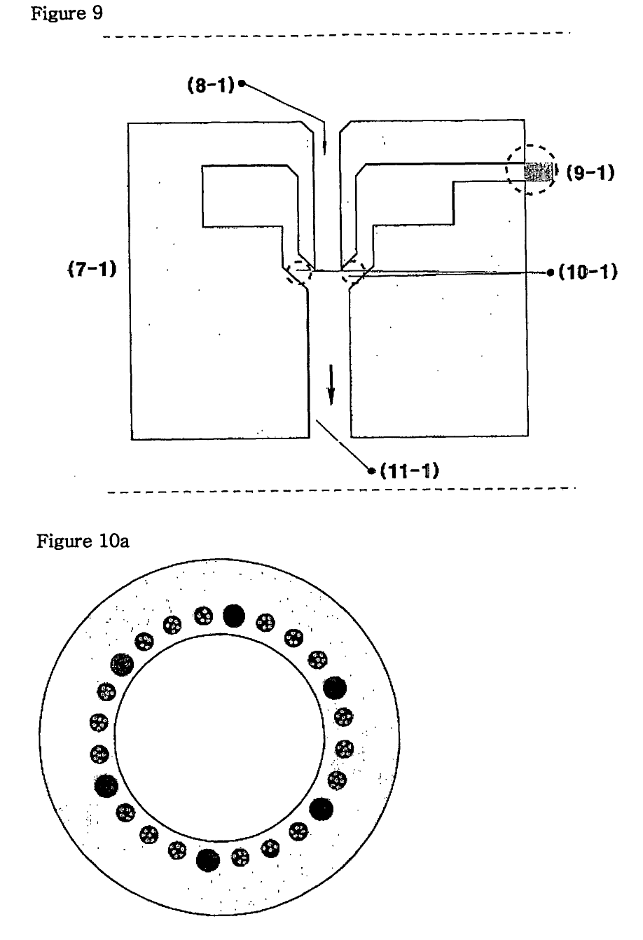

As shown in FIG. 6, because the hollow fiber membrane according to the present invention is connected to an internal coagulating solution injector and a wire extending to the centrally vertical axis of the spinneret, the hollow fiber membrane can be prepared through the automated processes, in which processes from the internal coagulating solution treatment to the spinning process are connected to a series of processes. Alternatively, the hollow fiber membrane can be prepared through the internal coagulating solution treatment and the spinning process in a manual way as shown in FIG. 9.

An apparatus for preparing the hollow fiber membrane according to the present invention includes: a central nozzle having an inlet for introducing the internal coagulating solution and the reinforcing supporter thereto and an outlet for discharging the hollow fiber membrane, the inlet extending along a centrally vertical axis; and a spinneret having an undiluted spinning solution nozzle communicating with the central side of the central nozzle, the undiluted spinning solution nozzle being formed for joining the internal coagulating solution, the reinforcing supporter and the undiluted spinning solution. The apparatus for preparing the hollow fiber membrane of the present invention is divided into the automated device further including an internal coagulating solution injector and the manually driving device for manually carrying out the internal coagulating solution treatment and the spinning process.

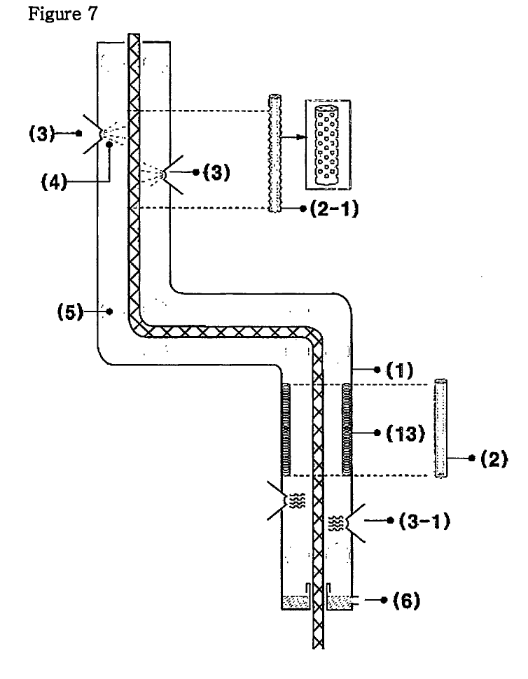

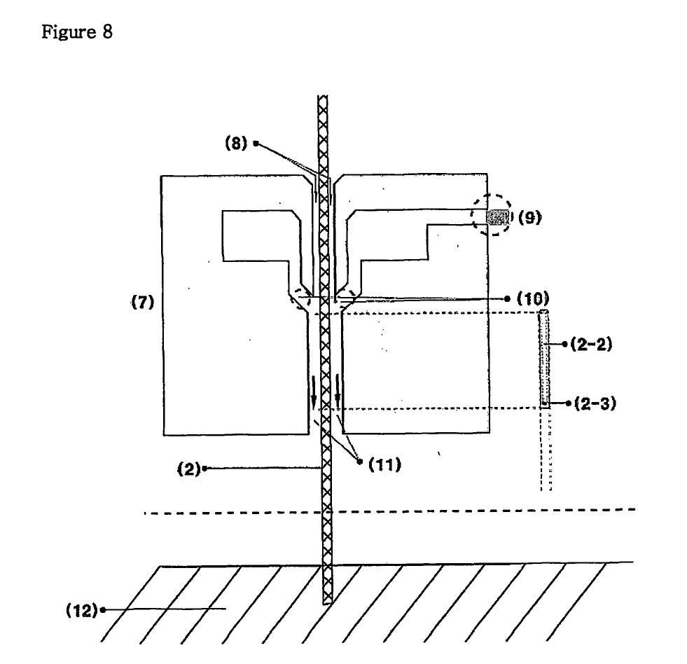

FIG. 6 is a sectional view of the automated device for preparing the hollow fiber membrane according to the present invention. The automated device includes an internal coagulating solution injector 1 shown in FIG. 7 and a spinneret 7 shown in FIG. 8. In concrete, the automated device includes the internal coagulating solution injector 1, and a wire 2 extending along the vertical axis of the center of the internal coagulating solution injector 1 and the spinneret 7 and having a side wall a part of which is perforated for inflow and discharge of the internal coagulating solution thereto and therefrom. In the automated device, the internal coagulating solution injector 1 and the spinneret 7 are connected to each other by the wire so as to automatically perform the internal coagulating solution treatment and the spinning process.

The internal coagulating solution injector includes a roller 5 for carrying the reinforcing supporter, a high pressure injection nozzle 3 for injecting the internal coagulating solution into the wire, an internal coagulating solution inlet 2-1 formed on the wire to correspond to the high pressure injection nozzle 3, a heater 13 and a high pressure hot blaster 3-1 for removing the internal coagulating solution of the outer surface of the reinforcing supporter, and an internal coagulating solution outlet 6 for discharging the internal coagulating solution collected after the use therefrom.

FIG. 9 is a sectional view of a spinneret for a manual wetting process according to another embodiment of the present invention. The manual device has the same structure as the automated device excepting the internal coagulating solution injector and the wire of the automated device.

A process for preparing the hollow fiber membrane of the present invention will now be described in more detail as follows.

First, polyester-based or nylon-based mono filaments or mixed mono filaments and multi filaments of 8 to 64 yarns are inserted into the weaving machine respectively to weave the tubular supporter. The supporter woven by the above has high tension strength and pressure resistance, and the diameter of the supporter can be controlled according to the number of cones.

Next, the tubular reinforcing supporter woven by the above is treated with alkali for the surface weight deduction of the supporter. The tubular reinforcing supporter weight-deducted is treated with the internal coagulating solution for control of internal pores before being coated with undiluted spinning solution.

The internal coagulating solution treatment is divided into the manual process and the automatic process. The manual process is a method that the reinforcing supporter is put into an internal coagulating solution tank, in which the internal coagulating solution is contained, for a predetermined period of time and then sends to the spinneret 7-1 of FIG. 9 in a wetted condition. The manual process has an advantage that additional devices are not needed.

As shown in FIG. 6, the automated device is a method for automatically sending the tubular reinforcing supporter to the spinneret 7 through the internal coagulating solution injector 1. The internal coagulating solution 4 is injected at a high pressure through the high pressure injection nozzle 3 while the reinforcing supporter passes the internal coagulating solution injector 1 by the roller 5, introduced to the inside of the wire 2 through the internal coagulating solution inlet 2-1 located on the upper end of the wire 2, and then, is discharged through the internal coagulating solution outlet 2-2 located at the lower end of the spinneret 7 along the wire 2 so as to control the pores inside the hollow fiber membrane. The internal coagulating solution stained on the outside of the reinforcing supporter during the above process is removed through the heater 13 and the hot blaster 3-1 located on the lower end of the internal coagulating solution injector 1. The automatic process from the internal coagulating solution treatment to spinning process performed in a short time along the central wire by the roller has a high productivity.

After the internal coagulating solution treatment, the tubular reinforcing supporter is sent to the spinneret, and then, the reinforcing supporter passing the wetting step in the manual process is manually sent to the spinneret 7-1 shown in FIG. 9. The spinneret shown in FIG. 9 includes a reinforcing supporter inlet 8-1, an undiluted spinning solution inlet 9-1, an undiluted spinning solution nozzle 10-1, and a hollow fiber membrane outlet 11-1. The supporter sent to the supporter inlet 8-1 is joined with the undiluted spinning solution discharged through the undiluted spinning solution nozzle 10-1 located at the central end of the spinneret 7-1 and coated with the undiluted spinning solution. After that, the coated supporter is spun through the hollow fiber membrane outlet 11-1, and the liquid type coating layer is converted into solid type while being inserted into an external coagulating solution 12. Through the above process, the supporter is coated completely, and forms the hollow.

In the automatic process, the reinforcing supporter passing the internal coagulating solution treatment (automatic internal coagulating solution discharging process using the internal coagulating solution injector) of the internal coagulating solution injector 1 of FIG. 7 is sent to the spinneret 7 of FIG. 8 along the wire 2. The spinneret 7 of FIG. 8 includes the wire 2, an internal coagulating solution inlet 8, an undiluted spinning solution inlet 9, an undiluted spinning solution nozzle 10, a hollow fiber membrane outlet 11, an internal coagulating solution outlet 2-2, and an internal coagulating solution shield 2-3. The supporter introduced into the supporter inlet 8 along the wire 2 is spun to the hollow fiber membrane outlet 11 as in the manual process, and then, introduced into the external coagulating solution 12 along the wire 2 extending to the inside of the external coagulating solution 12, and thereby the hollow fiber membrane is formed.

FIG. 10a is a sectional view of the hollow fiber membrane having the reinforcing supporter by mixed spinning of the mono-filaments and multi-filaments when a wire is used.

FIG. 10b is a sectional view of the hollow fiber membrane having the reinforcing supporter by mixed spinning of the mono-filaments and multi-filaments when the wire is not used.

FIG. 10c is a photograph of the hollow fiber membrane of FIG. 10a.

FIG. 11 is a sectional view of the hollow fiber membrane having the reinforcing supporter woven only with the mono-filaments. As shown in FIGS. 10 and 11, the hollow fiber membrane prepared through the automatic process using the wire has a round inner hollow, but the hollow fiber membrane prepared through the manual process, which does not use the wire, has an irregular round inner hollow.

However, when the wire is not used, as shown in FIG. 10a, the hollow of the hollow fiber membrane may be shown in the form of a round.

The dope used for coating the reinforcing supporter according to the present invention is made of polymer, additive and solvent. The polymer is selected from polyacrylo nitrile, polyacrylo nitrile copolymer, polysulfone, sulfonated polysulfone, polyether sulfone, cellulose acetate, cellulose triacetate, polymethyl methacrylate, and groups made of mixture of the above ingredients. The additive is selected from water, methyl alcohol, ethyl alcohol, ethylene glycol, polyethylene glycol, polypropylene glycol, glycerin, PVP(Poly-vinyl Pyrrolidone), and groups made of mixture of the above ingredients. The solvent is selected from NMP(N-methyl-2-pyrrolidone), DMF(dimethyl formamide), DMAc(dimethyl acetamide), chloroform, tetrahydrofuran, and groups made of mixture of the above ingredients.

Differently from the conventional hollow fiber membrane using only the multi-filaments, the hollow fiber membrane according to the present invention improves softness of the membrane by using the mono-filaments, preferably less than 150 deniers, and increases bonding force to the selectively permeable membrane (separating filtration layer) by the surface weight deduction treatment of the supporter. Moreover, the present invention increases more concave-convexo portions of the supporter surface by preparing the supporter, in which the mono-filaments and the multi-filaments are mixed at the predetermined ratio, thereby preventing coming-off of the selectively permeable membrane due to shock. Furthermore, the present invention can control the inner pore size of the membrane by passing the wetting process (or the internal coagulating solution discharging process) for wetting the woven tubular supporter into the internal coagulating solution.

The internal coagulating solution is to form the hollow, and selected from water, NMP(N-methyl-2-pyrrolidone), DMF(dimethyl formamide), chloroform, tetrahydrofuran, polyethylene glycol, propylene glycol, ethylene glycol, and mixture of the above ingredients. According to circumstances, an additive, such as PVP(Poly-vinyl Pyrrolidone), may be added to the internal coagulating solution.

The external coagulating solution may be used in the same way as the internal coagulating solution.

### INDUSTRIAL APPLICABILITY

As described above, the hollow fiber membrane according to the present invention has excellent pressure resistance and high tension force by using the rigid and tubular supporter, an improved softness by using the mono-filaments, and an increased bonding force between the supporter and the coating layer by increasing the concave-convexo degree of the reinforcing supporter. Additionally, the present invention can prevent detachment of the separating filtration layer, which is the coating layer, through the surface weight deduction treatment of the reinforcing supporter, and control the inner pore size of the membrane by treating the internal coagulating solution, thereby providing an excellent water-permeability.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An external pressure type hollow fiber membrane having a reinforcing supporter for supporting a separating filtration layer for gas separation and water treatment, wherein the reinforcing supporter is woven only with mono-filaments or by mixed spinning of mono-filaments and multi-filaments.

2. The hollow fiber membrane according to claim 1, wherein the mixed ratio of the mono-filaments and the multi-filaments or the multi-filaments and the mono-filaments is 1:1 to 63:1.

3. The hollow fiber membrane according to claim 2, wherein the mixed ratio of the mono-filaments and the multi-filaments or the multi-filaments and the mono-filaments is 2:1 to 7:1.

4. The hollow fiber membrane according to claim 1, wherein the thickness of the mono-filament is 30 to 450 deniers.

5. The hollow fiber membrane according to claim 1, wherein the thickness of the multi-filament is 30 to 150 deniers.

6. The hollow fiber membrane according to claim 1, wherein the reinforcing supporter is made with 8 to 64 yarns, and the number of the yarns is increased by multiple of 8.

7. The hollow fiber membrane according to claim 1, wherein the reinforcing supporter is made of polyester, nylon, polypropylene or the like.

8. The hollow fiber membrane according to claim 1, wherein 0.1 to 80% of polymer constituting the separating filtration layer is inserted into the reinforcing supporter.

9. The hollow fiber membrane according to claim 1, wherein the reinforcing supporter is a weight-deducted supporter.

10. A method for preparing an external pressure type hollow fiber membrane having a reinforcing supporter with mono-filaments for gas separation and water treatment, the method comprising the steps of:
weaving the reinforcing supporter only with mono-filaments or by mixed spinning of the mono-filaments and multi-filaments; and
coating the reinforcing supporter with dope in a spinneret and discharging it to external coagulating solution to form the hollow fiber membrane.

11. The method according to claim 10, further comprising the step of treating the reinforcing supporter with internal coagulating solution.

12. The method according to claim 10, further comprising the step of applying surface weight deduction treatment to the reinforcing supporter with alkali.

13. The method according to claim 10, wherein the hollow fiber membrane is prepared through an automatic process carried out in a series from an internal coagulating solution treatment to a spinning process by connecting an internal coagulating solution injector and the spinneret with a wire extending to a vertical axis of the center of the spinneret.

14. The method according to claim 10, wherein the hollow fiber membrane is prepared through a manual process that the internal coagulating solution treatment and the spinning process are carried out manually.

15. An apparatus for preparing an external pressure type hollow fiber membrane having a reinforcing supporter with mono-filament for gas separation and water treatment, the apparatus comprising:
a central nozzle extending along a centrally vertical axis, the central nozzle having inlets for introducing internal coagulating solution(4) and the reinforcing supporter thereto and a hollow fiber membrane outlet(11-1); and
a spinneret(7) communicating with the central side of the central nozzle, the spinneret(7) having an undiluted spinning solution nozzle(10) formed to join the internal coagulating solution, the reinforcing supporter and undiluted spinning solution.

16. The apparatus according to claim 15, further comprising:
an internal coagulating solution injector(1); and
a wire(2) extending along a centrally vertical axis of the internal coagulating solution injector(1) and the spinneret(7), the wire(2) having a part of a side wall a part of which is perforated for introducing and discharging the internal coagulating solution thereto and therefrom,
wherein an internal coagulating solution treatment and a spinning process are automated by connecting the internal coagulating solution injector(1) and the spinneret(7) to each other through the wire(2).

17. The apparatus according to claim 16, wherein the internal coagulating solution injector(1) includes a roller(5) for carrying the reinforcing supporter, a high pressure injection nozzle(3) for injecting the internal coagulating solution into the wire(2), an internal coagulating solution inlet(2-1) formed on the wire to correspond to the high pressure injection nozzle(3), a heater(13) and a hot blaster(3-1) for removing the internal coagulating solution of the outer surface of the reinforcing supporter, and an internal coagulating solution outlet(6) for discharging the internal coagulating solution collected after the use therefrom.
